(19) United States
(12) Patent Application Publication
(10) Pub. No.: US 2019/0311596 A1
(43) Pub. Date: Oct. 10, 2019

(54) ENHANCED GPS TRACKING DEVICES AND ASSOCIATED METHODS

(71) Applicant: GoFind Inc., Richardson, TX (US)

(72) Inventors: Anthony Valentino, Richardson, TX (US); Ronald Kasper, Los Gatos, CA (US)

(21) Appl. No.: 16/380,967

(22) Filed: Apr. 10, 2019

Related U.S. Application Data
(60) Provisional application No. 62/655,626, filed on Apr. 10, 2018.
(60) Provisional application No. 62/655,630, filed on Apr. 10, 2018.
(60) Provisional application No. 62/655,642, filed on Apr. 10, 2018.

(51) Int. Cl. G08B 21/02; G01S 19/16; H04W 4/021; H04W 4/029

(52) U.S. Cl. CPC G08B 21/0269; H04W 4/029; H04W 4/021; G01S 19/16

(57) ABSTRACT

Enhanced GPS device and methods operate to configure the operating parameters of the GPS device according to a tracking application mode received at the GPS device. The tracking application mode is selected by a user. In some embodiments, the tracking application mode is used by the GPS device to configure the operating parameters by selecting an operating profile from a plurality of pre-set profiles in memory of the GPS device. In some embodiments, the operating parameters include a geofence. In some embodiments, the geofence may be created by the GPS device based on on-device data without interaction by the GPS device with a remote device.

### CROSS-REFERENCE TO RELATED APPLICATIONS

This application benefits from and claims priority to U.S. Patent Application Ser. No. 62/655,626, filed on Apr. 10, 2018. This application also benefits from and claims priority to U.S. Patent Application Ser. No. 62/655,630, filed on Apr. 10, 2018. This application also benefits from and claims priority to U.S. Patent Application Ser. No. 62/655,642, filed on Apr. 10, 2018. Each of the aforementioned applications is incorporated by reference in their entireties herein.

### BACKGROUND

GPS trackers have been available for a number of years primarily within the Business-to-Business environment. With the advent of cost-effective cellular modems and GPS receivers, GPS tracking products are proliferating in the consumer electronics market, for tracking and displaying vehicle information, and tracking animals, as well as other consumer assets. For example, consumers are now able to track cars, bicycles, children and elderly people, and pets as well as any consumer asset that they wish.

With the addition of low cost sensors, trackers can now incorporate additional functionality to provide users with more than just location data. Typically, the GPS in these trackers are combined with a cellular modem to transmit data from the tracker to a server and then ultimately to a smartphone where the user can extract and display the relevant information.

GPS tracking systems frequently include the creation and management of geofences. A geofence is a virtual geographic boundary, defined by GPS technology that enables software to trigger a response when a GPS device enters or leaves a particular area. For example, in a business, a geofence can be placed around a destination and the fleet manager can be alerted when a vehicle reaches that destination; or in a consumer environment, the GPS tracker can issue an alert to a smartphone whenever a person or pet enters or exits a geofence that has been placed around the user's home.

### BRIEF DESCRIPTION OF THE FIGURES

FIG. 1 illustrates a GPS tracking environment, in embodiments.

FIG. 2, depicts a screenshot of one embodiment of the application running on the remote device.

FIG. 3 depicts a block diagram of example firmware for implementing a multi-modal GPS tracker, in embodiments.

FIG. 4 depicts a block diagram of a method for configuration of a multi-mode GPS device, in embodiments.

FIG. 5 depicts a block diagram of a traditional system for implementing geofences.

FIG. 6 depicts a block diagram of example firmware for implementing a geofence-based power control of a GPS tracker, in embodiments.

FIG. 7 depicts a block diagram of a method for power management of a GPS device based on on-device geofence, in embodiments.

FIG. 8 depicts a block diagram of a method for operating a GPS device between a plurality of power states, in embodiments.

FIG. 9 depicts a block diagram of example firmware for implementing an automatic geofence creation in a GPS tracker, in embodiments.

FIG. 10 depicts a block diagram of a method for automatic on-device creation of a geofence, in embodiments.

### DETAILED DESCRIPTION OF THE EMBODIMENTS

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

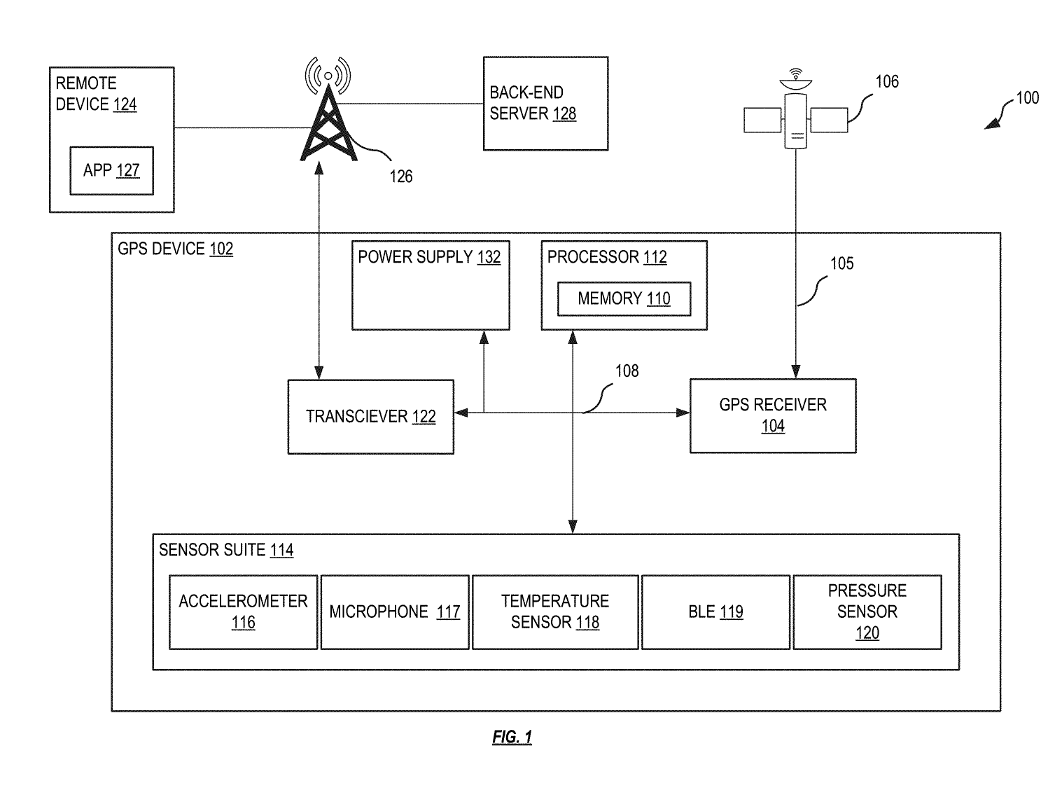

FIG. 1 illustrates a GPS tracking environment 100, in embodiments. The GPS tracking environment 100 includes a GPS device 102 for tracking an object (e.g., a car, a bicycle, a person, a pet, a device such as a phone, computer, or other device, etc.). The GPS device 102 includes a GPS receiver 104 that receives positional data 105 from a GPS satellite 106. The positional data 105 may be relayed via a communications/data bus 108 for storage in memory 110 and analysis using processor 112 to calculate a position of the GPS device 102 based on the positional data 105. The processor 112 represents one or more processors or computing devices. The memory 110 is operatively coupled to the processor and stores computer readable instructions that when executed by the processor 112 cause the processor 112 to implement the functionality of the GPS device 102 described herein.

In embodiments, the GPS device 102 further includes a sensor suite 114 for sensing additional data of the GPS device 102. For example, the sensor suite 114 may include one or more of an accelerometer 116, a microphone 117, a temperature sensor 118, a Bluetooth Low Energy Sensor 119, and a pressure sensor 120. Additional and/or alternative sensors, such as but not limited to one or more of a gyroscope, magnetometer, heart rate sensor, and hydration sensor, may be included in the sensor suite 114 without departing from the scope hereof. In embodiments, the data captured by the one or more sensors in the sensor suite 114 are stored in the memory 110 for processing using the processor 112. The memory 110 may represent volatile and/or non-volatile memory. The processor 112 may represent a single processor or multiple processors working in concert.

In embodiments, the GPS device 102 includes a cellular transceiver 122 for transmitting information to, and receiving information from a remote device 124 via a network hub 126. The cellular transceiver 122 further allows the GPS device 102 to communicate with a back-end server 128, that, in embodiments, performs one or more of the following: monitoring of data captured by the GPS device 102, configuration control of the GPS device 102, communication with associated remote device(s) 124 paired with GPS device 102, as well as other functions and services. The transceiver 122 is a wireless or wired transceiver, such as a cellular, WiFi transceiver, Bluetooth, or any other wireless protocol. The network hub 126 is a relay device for relaying information from and to the transceiver 122 according to the protocol implemented by the transceiver 122. The remote device 124 is one or more of an external server, a computer, a mobile device such as a smartphone, tablet, laptop, etc. The remote device 124 may be operated by a third party associated with the object tracked using the GPS device 102. For example, the remote device 124 may be a caregiver of a person, an owner of a car, an owner of a pet, an owner of a bicycle, etc. As such, the remote device 124 may be “paired” with the GPS device 102. Paired herein means the remote device, backend server, or other device is directly paired with the GPS device, or that a device identifier has been associated with the GPS device. For example, the remote device 124 may be “paired” with the GPS device 102 via transmitting of a phone number, or a IP address, indicating how the GPS device 102 can communicate with the remote device 124. When paired together, an identifier of the GPS device 102 and the remote device 124 (as well as any other identifying information such as IP addresses, operating entity, etc.), are stored on one or more of the remote device 124, the GPS device 102, and a back-end server such that the remote device 124 and the GPS device 102 can communicate between each other. Accordingly, the remote device 124 may include an application 127 (such as a phone application, or a web-based browser application) for interacting with the GPS device 102, and interfacing with data captured thereby (such as the positional data 105, or the data from the sensor suite 114).

Components within the GPS device 102 are powered via a power supply 132, which may be managed using the processor 112 executing computer readable instructions stored within the memory 110.

### Multi-Modal GPS Tracker:

The increase in development and use of GPS tracking systems creates a need for a system that is capable of use for a variety of vertical market segments. This disclosure appreciates that each market segment application each of these tracker types brings with it a different use case. A tracker for a car for example will have different settings for updating its position versus a tracker for a dog. Updates must occur more frequently for a car as it travels much faster than a dog.

Similarly, activity data for a dog will be different than activity data for the rider of a bicycle which would be different from the activity data for an elderly person. So even with a common electronics platform, the firmware that powers the tracker and the smartphone apps which deliver data to the user may be quite different. Couple that with the different mechanical cases that are needed, and the manufacturing and inventory part numbers start to become difficult to manage.

To solve this problem and to develop a truly universal tracker, it is necessary to develop not only a common hardware platform (such as the GPS device 102 shown in FIG. 1), but also a common firmware platform and a common application (such as the application 127 in FIG. 1). In addition, data from the internal sensors (such as the data from sensor suite 114) may be implemented in a new and unique manner to tailor the behavior of the GPS device 102 to the specific tracking application and thereby optimize its performance in a given tracking application.

In looking at the firmware, one begins to realize that many of the tasks are common. Receiving and transmitting the positional data 105 is basically the same throughout each tracker application. Using geofences is also basically the same as is collecting activity data or vehicle data from the sensor suite 114. While the data may be different, the sensors used and the methodology of collecting and transmitting the data is basically the same across tracker platforms. What remains then is how to combine this information into a common firmware platform.

Embodiments of the present application allow for a user, via the remote device 124 and application 127 running thereon, to customize the GPS device 102 for a specific tracking application. This allows the GPS device 102 to provide multi-modal capability.

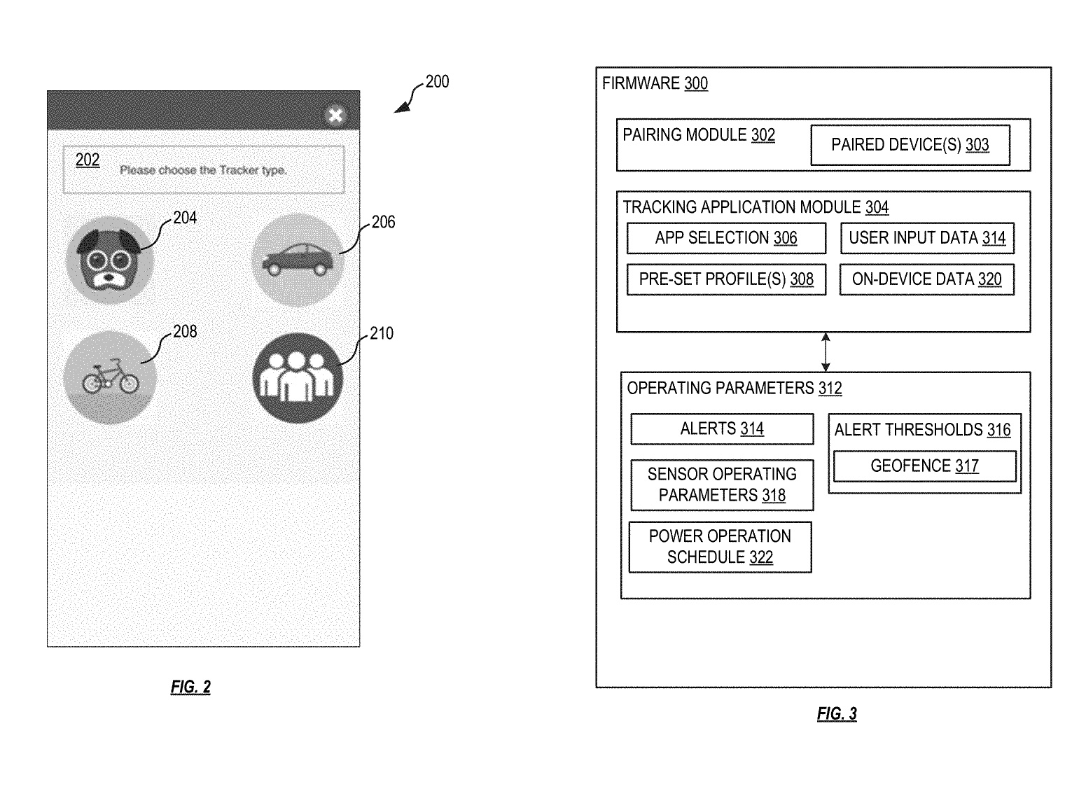

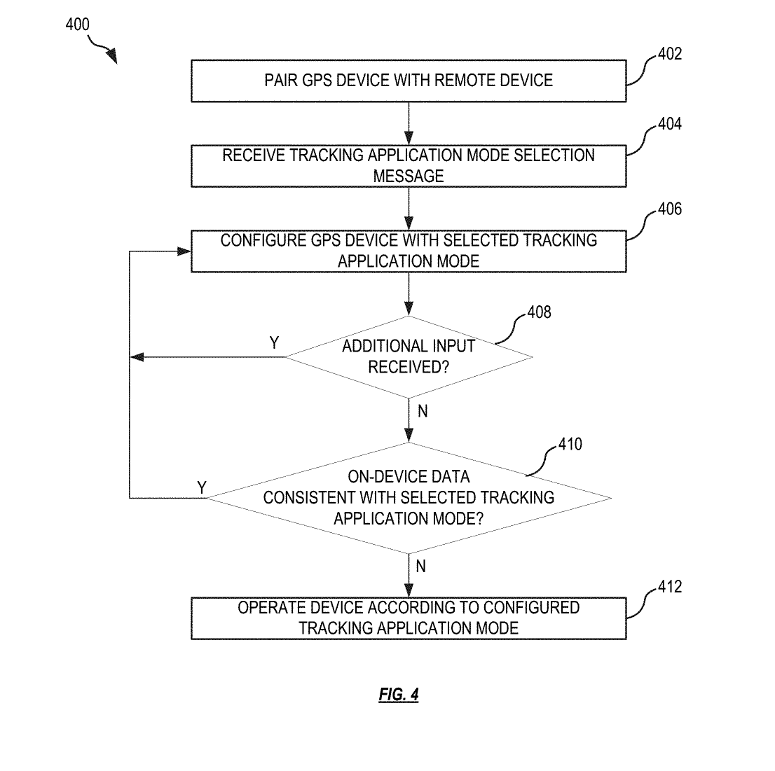

FIG. 2, depicts a screenshot 200 of one embodiment of the application 127 running on the remote device 124. FIG. 3 depicts a block diagram of example firmware 300 for implementing a multi-modal GPS tracker, in embodiments. The firmware 300 may be implemented in one or both of the processor 112 and memory 110 of the GPS device 102, of FIG. 1.

For example, The GPS device 102 may include a button (not shown) that initiates a pairing module 302 of the firmware 300. The pairing module 302 comprises computer readable instructions stored within the memory 110 that when executed by the processor 112 operate to pair the GPS tracker 102 with the remote device 124. The pairing process may include displaying a PIN or other handshake information within the application 127 to verify the correct GPS device 102 is being paired with the correct remote device 124. Once paired, the identification information of each paired device may be stored in the firmware 300 as paired device(s) 303. This paired device(s) list 303 may be offloaded or otherwise transmitted to the remote device 124, another server, and/or third-party device.

Once paired (or otherwise registered with) the remote device 124, the firmware 300 may implement a tracking application module 304. The tracking application module 304 comprises computer readable instructions stored within the memory 110 that when executed by the processor 112 operate to configure the GPS device 102 to a specific tracking application. After the GPS device 102 and remote device 124 are paired, setup of the GPS device 102 may be implemented in which a prompt 202 is presented to the user of the remote device 124 via the application 127 displayed on a display of the remote device 124. This beneficially allows the GPS device 102 to not require a display—although some embodiments of the GPS device 102 may include a display.

Initiation of the prompt 202 may be controlled via the application 127, or via a signal sent from the GPS device 102 to the remote device 124. In the example of screenshot 200, the application 127 displays a prompt 202 requesting the user of the remote device 124 to select a pre-set tracking application. For example, screenshot 200 depicts tracking applications including pet 204, vehicle 206, bicycle 208, and person 210. More or fewer options may be implemented, as well as different types of tracking applications, without departing from the scope hereof.

Upon selection of a tracking application in response to the prompt 202, the remote device 124 may transmit a tracking application mode selection message 306. The tracking application selection message 306 may be a SMS message, or other data transmission protocol message that includes the user's selection of one of application types (e.g., pet 204, vehicle 206, bicycle 208, and person 210) displayed in the application 127 with prompt 202.

In response to receipt of the tracking application selection message 306, the tracking application module 304 parses the message 306 and selects one of a pre-set profile 308 stored within the memory 110. In certain embodiments the pre-set profile 308 is included in the tracking application selection message 306 as configuration parameters that are sent from a back-end server in response to the user's selection of the application type being received at the back-end server. These embodiments provide the advantage that if the user selects an application type that does not correspond to a pre-set profile 308 stored within the memory 110 located on the GPS device 102, the GPS device 102 may be configured via a firmware 300 update included in the tracking application selection message 306.

The corresponding profile 308 is then used to configure operating parameters 312 which define operation schedules of the GPS device 102. For example, the operating parameters 312 may include one or more of alerts 314, alert thresholds 316, and sensor operating parameters 318. The alert thresholds 316 may include an associated geofence 317, as well as other thresholds discussed below. The sensor operating parameters 318 may define which sensors within the sensor suite 214 to activate, what data the given sensor is to capture (e.g., use the accelerometer 116 to monitor steps of the object wearing the GPS device 102, use the microphone 117 to monitor ambient noise levels, use the temperature sensor 118 to monitor the ambient temperature around the GPS device 102, use the BLE 119 to detect presence or absence of an authorized phone nearby, and/or use the pressure sensor 120 to determine associated altitude of GPS device 102), and any specific data capture intervals for each sensor within the sensor suite 214 (e.g., every N seconds, from 8 AM to 8 PM, when outside of a given geofence (e.g., geofence 317), when inside of a given geofence, etc.). The alerts 314, as discussed in more detail below, include alert definitions (e.g., one or more of a speed alerts, fall alerts, geofence breach alert), and when/where to transmit the alert from the GPS device 102 to remote device 124 and/or back-end server 128, etc.

In embodiments, the tracking application module 304 further defines operating parameters 312 based on user input data 314 that is received at the GPS device 102 from the remote device 124. The user input data 314 is input by the user of the remote device 124 into the application 127. User input data 314 may include user-defined geofences that are then stored as geofence 317 when included in the operating parameters 312, object information (such as vehicle make/model/year, or tracked person's name, age, weight, and/or other information; pet's species, name, weight, age, etc.), requested alerts (such as speed alerts, fall alerts, activity alerts, etc.).

In embodiments, the tracking application module 304 further defines operating parameters 312 based on on-device data 320. The on-device data 320 includes data received from the sensor suit 114 that may modify the operating parameters 312 during the setup of the GPS device 102, and/or during the operation of the GPS device 102. For example, positional data 105 may indicate that a tracked object is in a city vs a rural environment, which may require modification of the sensor data capture intervals.

As another example, where the GPS device 102 is configured in a vehicle tracking application type (e.g., type 206), and the GPS device 102 includes a BLE sensor (e.g., BLE sensor 119), the operating parameters 312 may indicate to monitor paired devices 303 and, when the BLE sensor 119 cannot detect a paired device in the paired device list 303, then to activate the microphone 117 and modify the interval for receipt of the positional data 105. This allows the GPS device 102, when in vehicle tracking application mode, to save battery power when the user of the GPS device 102 is in the car by placing the GPS device 102 into a low-power mode that includes a first activation interval defining when the GPS receiver 104 and/or the sensors in the sensor suite 114 are to be activated, the first activation interval being longer than a second activation interval defined by the high-power mode. The low- and high-power modes may be defined in the power operation schedule 322. When the user exits the car and takes his/her phone (which is registered in the paired devices list 303), the GPS device 102 will activate the microphone 117 and control the GPS receiver 104 to capture positional data 105 more frequently. Thus, when the user is away from his/her vehicle, as detected by the BLE sensor 119 indicating absence of the user's phone within range of the BLE sensor 119, heightened tracking of the vehicle may occur to monitor the location of the vehicle more frequently, and monitor ambient noise via the microphone 117 to detect potential glass break and unauthorized entry as defined in a change in the ambient noise level above a defined threshold within a defined period. Absence of the user's phone from range of the BLE sensor 119 may further activate a geofence (e.g., geofence 317) around the current location of the vehicle (e.g., a 100 ft radius), and breach of the geofence (as indicated by the positional data 105) could cause the GPS device 102 to transmit an alert to the remote device 124 paired with the GPS device 102 as defined in the paired devices list 303.

As another example, in the case of a pet tracking application mode (e.g., type 204), when a paired device in the paired device list 303 is detectable by the BLE sensor 119, the owner of the pet likely knows where the pet is and thus the power mode may be reduced (e.g., reduced interval time for receiving positional data 105, reduced or no activation of microphone 117 (or other sensors in the sensor suite 114), etc.). However, when the BLE sensor 119 ceases to detect the paired device in the paired device list 303, this is indicative that the pet is no longer near the owner and thus the tracking of the pet is increased (e.g., shortened interval for receiving the positional data 105.

Table 1 below depicts example alerts 314 that are defined by the operating parameters 312 for five different application types. Type 0 defines a pet tracking application, Type 1 defines a vehicle tracking application, Type 2 defines a bicycle application, Type 3 defines a first person tracking application type, Type 3 defines a second person application tracking type.

TABLE 1
Operating Parameter Alerts

| Alert: | Type 0 | Type 1 | Type 2 | Type 3 | Type 4 |
|---|---|---|---|---|---|
| Outside Geofence | X | X | X | X | X |
| Inside Geofence | X | X | X | X | X |
| Low battery | X | X | X | X | X |
| Activity reminder | | | | X | X |
| Fall | | | X | X | X |
| Stairs up and down | | | | X | X |
| Hi/Low Temp | X | X | | X | X |
| Hard Cornering | | X | | | |
| Hard Acceleration | | X | | | |
| Hard Stop | | X | | | |
| Training SMS | X | | | | |
| Pre-shutdown | X | X | X | X | X |
| Locate now | X | X | X | X | X |
| SOS | | X | X | X | X |
| Device not worn | | | | X | X |
| Power off | X | X | X | X | X |
| Overspeed | | X | | | |

Activation of these alerts 314 may occur via detection of breach within the data captured by the sensor suite 114 or the positional data 105 of one or more alert thresholds 316 as defined within the operating parameters 312.

For example, the outside geofence and inside geofence alerts in table 1, the processor 112 may execute the firmware 300 to monitor the positional data 105 to determine if the GPS device 102 is within a given geofence (e.g., geofence 317) for a given period of time. Different tracking applications may utilize different time-period thresholds. For example, a pet application mode may have a 60 second time-period threshold such that if the pet is outside the geofence (e.g., geofence 317) for more than 60 seconds, an alert is generated. Alternatively, the vehicle application tracking mode may have a shorter time-period threshold because the vehicle moves faster than a pet such that if the vehicle is outside of the geofence (e.g., geofence 317) for 15 seconds, an alert is generated. Bike and person-based tracking application modes may have time-period thresholds between 15 and 60 seconds. It should be appreciated that these values are examples and any value for the time-period threshold may be utilized for any given tracking application mode without departing from the scope hereof.

To generate the fall alert, the processor 112 may monitor thresholds within the alert threshold list 316 that are associated with the accelerometer 116 and/or pressure sensor 120. For example, if data from the accelerometer 116 indicates a movement greater than 0.75 g over a 30 msec timeframe, this may be indicative of a freefall. Alternatively and/or additionally, a 1 meter pressure differential detected within 2 seconds after this accelerometer data signature may be used to verify a fall occurrence that warrants generation of the fall alert. Stairs up/down, may similarly monitor thresholds associated with data from the accelerometer 116 and/or pressure sensor 120. For example, movement on the accelerometer indication greater than 0.185 g over 2 seconds, coupled with pressure sensor differential of plus or minus 3 meters indicates stair movement up or down respectively.

High/low temperature alerts in table 1 may be associated with threshold levels defined in the alert threshold list 316 for data generated by the temperature sensor 118.

Hard cornering, hard acceleration, and hard stop alerts in table 1 may be associated with threshold levels defined in the alert threshold list 316 for data generated by the accelerometer 116.

Training SMS alerts may be generated in response to receipt of a prompt, generated at the remote device 124 and received by the transceiver 122, indicating to tell the pet to sit, speak, wait, etc.

Overspeed alerts in table 1 may be associated with threshold levels defined in the alert threshold list 316 for positional data 105 generated by GPS receiver 104, and/or the data from the accelerometer 116.

The alert thresholds 316 may be pre-configured, set by a user via the remote device 122, and/or modified based on historical data captured by the GPS device 102 and define conditions of the GPS device 102 required to trigger an alert 314 transmission from the GPS device 102 to one or both of the remote device 124 and back-end server 128. For example, the server 128 may collect and store historical data on a presumed fall (acceleration, pressure, orientation, and false fall alarms). Over time, the server 128 may determine which alert thresholds 316 need to be adjusted to minimize the occurrence of false alarms. Those parameter changes are then sent to the GPS device 102 over-riding the default alert thresholds 316.

In embodiments, the processor 112 may monitor the on-device data 320 to identify jitter in the on-device data, and in response modify an alert threshold 316 associated with the sensor collecting the on-device data having the jitter. For example, if the GPS device 102 is reporting very quick changes (jitter) in the geofence alarm (i.e. reporting that it is outside a geofence (e.g., geofence 317) and then a short time later reporting it is inside a geofence (e.g., geofence 317)). This can occur if the GPS device 102 is located near the edge of a geofence (e.g., geofence 317) and is stationary. Here the errors which are always present in the positional data 105, could at one moment put the GPS device 102 outside the geofence (e.g., geofence 317) and in the next moment put the GPS device 102 inside the geofence (e.g., geofence 317) thus sending false alarms. In certain embodiments, in response to this condition, the server 128 would monitor these rapid changes and sends a command to the GPS device 102 to modify the geofence (e.g., geofence 317) boundary in the alert thresholds 316 to compensate for these errors.

In embodiments, the activity application type is determined automatically, or modified in response to the on-device data 320. The server 128, for example, may collect data captured by the GPS device 102 (such as location patterns, speed, gait), and use that data to determine which tracking application mode should be used and send a command to the tracker to change its profile. The server 128 may thus implement an artificial intelligence or machine learning algorithm that captures the on-device data 320 from the sensor suite 114 and positional data 105, and automatically adapts the GPS device 102 for a given tracking application mode, as well as for the specific object being tracked. For example, if the tracker reports that it is traveling at 25mph and its location is constantly changing, it is not a dog tracker, so a tracking application mode change is in order. Another example is in fall detection.

Multi-modal GPS device 102 not only provides benefits to the device itself, but also to the application 127 running on remote device 124. Once the GPS device 102 application tracking mode is set, the application 127 may be controlled to only allow the user of the remote device 124 to have access to features of the application 127 that are associated with that given application tracking mode. By modifying the GPS device 102 to a specific tracking application mode, the battery life is extended because the GPS device 102 is not activating specific sensors, or not using the sensors more than necessary.

The above discussed multi-modal GPS device 102 allows for a single hardware package to be implemented to a variety of application modes. This not only provides simpler inventory management for a manufacturer, but also advantages to the user in that a given purchased product may be adapted to a variety of uses depending on the user's desires.

FIG. 4 depicts a block diagram of a method 400 for configuration of a multi-mode GPS device, in embodiments. Method 400 is implemented using the system described above and depicted in FIGS. 1-3.

In block 402, a GPS device is paired with a remote device. In one example of operation of block 402, the GPS device 102 is paired with one or more remote devices 124. Upon pairing, the identifying information of each device (e.g., IP addresses, operating entity, etc.), is stored in the paired devices list 303. In certain embodiments of block 402, once paired, the paired devices list 303 may be transmitted and stored at any one or more of GPS device 102, remote device 124, and back-end server 128.

In block 404, a tracking application mode selection message is received. In one example of block 404, the GPS device 102 receives tracking application mode selection message 306 in response to user interaction with the application 127 running on remote device 124. In another example of block 404, the back-end server 128 receives tracking application mode selection message 306 in response to user interaction with the application 127 running on remote device 124.

In block 406, the GPS device is configured according to the selected tracking application mode defined in the tracking application mode selection message of block 404. In one example of block 406, the GPS device 102 configures itself according to one of a plurality of pre-set profiles 308 stored within memory 110 (and/or firmware 300) of the GPS device 102. In another example of block 406, the back-end server 128 transmits configuration parameters as a firmware 300 update to configure the GPS device 102. This example provides the advantage that if the user selects an application type via application 127 that does not correspond to a pre-set profile 308 stored within the memory 110 located on the GPS device 102, the GPS device 102 may be configured via a firmware 300 update included in the tracking application selection message 306 received at the GPS device 102.

At block 408, the method 400 determines if additional input is received at the remote device 124 via user interaction with the application 127. If so, the method proceeds with block 406, else method proceeds with block 410. In one example of block 408, user input data 314 is received at one or both of GPS device 102 and back-end server 128. If so, the method 400 repeats block 406 and configures the GPS device 102 (either directly on the GPS device 102, or via a command from the back-end server 128 to the GPS device 102) according to the user input data 314. In such embodiments, the user, via interaction with application 127 may customize the operating parameters of the GPS device 102. This allows the user to expressly modify one or more aspects of pre-set profiles 308, such as specific alerts, alert thresholds, and sensor operating parameters.

At block 410, the method 400 determines if on-device data on the GPS device 102 indicates a change in operating parameters of the GPS device is necessary. If so, the method proceeds with block 406, else method proceeds with block 412. In one example of operation of block 410, the server 128, for example, may collect on-device data 320 captured by the sensor suite 114 and GPS receiver 106 of GPS device 102 (such as location patterns, speed, gait), and use that data to determine which tracking application mode should be used and send a command to the GPS device 102 to change its operating parameters 312. The server 128 may thus implement an artificial intelligence or machine learning algorithm that captures the on-device data 320 from the sensor suite 114 and positional data 105, and automatically adapts the GPS device 102 for a given tracking application mode, as well as for the specific object being tracked. For example, if the GPS device 120 reports that it is traveling at 25mph and its location is constantly changing, it is not a dog tracker, so a tracking application mode change is in order. Another example is in fall detection. Although the above example is described as including processing on the back-end server 128, it should be appreciated that all processing of the on-device data 320 may be done on the GPS device 102 itself without departing from the scope hereof.

### Power Management Based on On-Device Geofence:

When a GPS tracker provides its position, it must activate its GPS receiver to calculate a position, then it activates its cellular transmitter to send that data to a server. The present disclosure acknowledges that these operations consume a lot of power and with the small size and small batteries of consumer devices, the battery life expectancy is measured in hours if the tracker is constantly tracking and reporting.

The present disclosure acknowledges that strategic use of a geofence can extend the battery life of the GPS device (e.g., GPS device 102) to days or weeks. For example, assume a user has a geofence centered around the user's home. If the GPS device were within the geofence, the user would know it was in a well-defined small area and thus would not need constant updates on its location. Thus, the interval between transmissions of data can be longer, the radios can be powered down, and battery life can be extended. However, if the GPS device is outside of the geofence, its position must be determined, the area of location is larger, and most likely the GPS device is moving, all of which require more frequent updates of the GPS device's position. The radios are therefore powered on for longer periods of time, consuming more power and decreasing battery life. So, the use of geofences to control power greatly aids in conserving power and extending battery life of GPS devices.

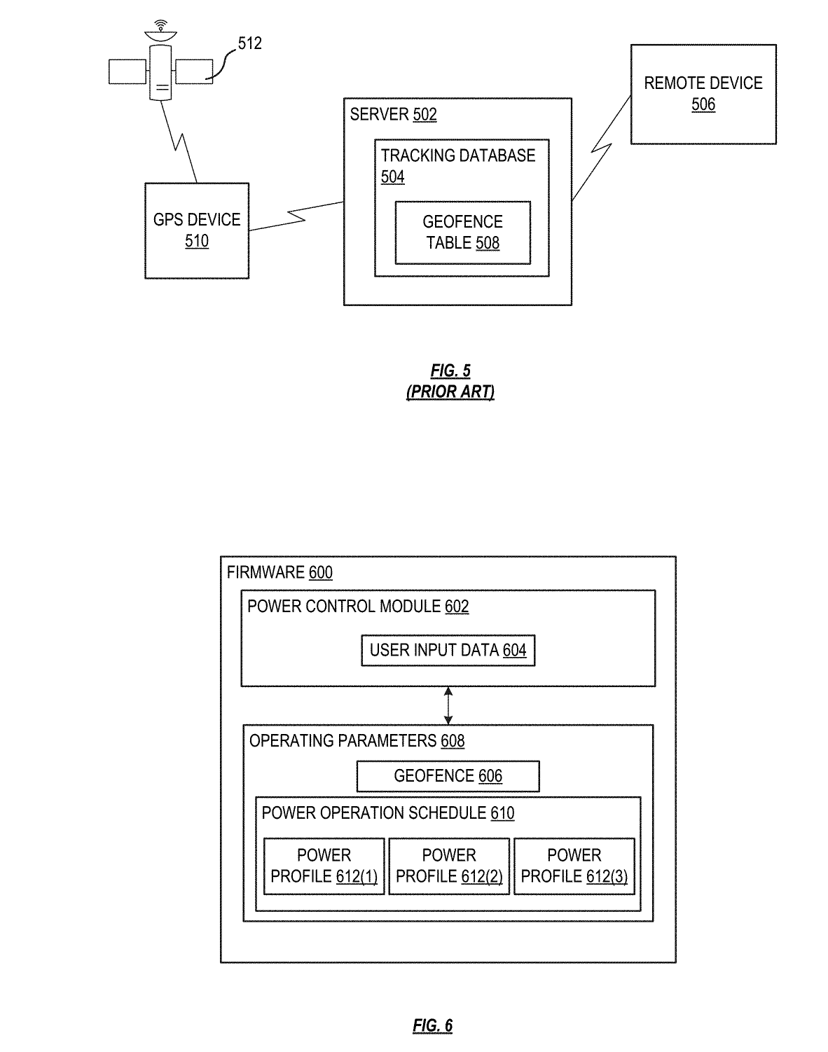

FIG. 5 depicts a block diagram of a traditional system 500 for implementing geofences. Traditionally, geofences are established within a cloud server 502 either via a direct input to a tracking database 504 at the cloud server 502 or via a message sent to the server 502 via a remote device 506. The inputs are in the form of a series of Latitude/Longitude points, or a Latitude/Longitude of the center of a circle along with the radius of the circle. The cloud server 502 then generates a geofence table 508 defining the geofence for a given GPS device 510 based on the defined Latitude/Longitude points, or the Latitude/Longitude of the center of a circle along with the radius of the circle. This process and system is manual, and requires user interaction with the system 500 to create a given geofence.

Based on the created geofence table 508 at the server 502, the server 502 then takes the position of the GPS device 510 (as received by the GPS device 510 from receipt of signals from GPS satellites 512) and calculates whether the position of the GPS device 510 is either inside or outside of the geofence defined in the geofence table 508 for the given GPS device 510. Upon this determination, the server 502 transmits the appropriate alert to the remote device 506 and then notifies the tracker whether it needs to keep the radios of the GPS device 510 (such as the cellular radio for transmission of data to the server 502, and the GPS receiver for interacting with the satellites 512) powered on or whether it can put the radios to sleep. While this approach works, it is dependent upon the GPS device 510 being connected to the server 502 in order for the GPS device 510 to receive the server notification of whether or not it is inside the geofence and how to control/power the radios of the GPS device 510. This process is ineffective for using the geofence for power managing the GPS device 510, because to keep the connection between the GPS device 510 and the server 502 alive, the cellular radio of the GPS device 510 needs to be on and looking for data sent by the server 502. The server 502 cannot send messages autonomously as network operators (the cellular carriers) consider autonomous server messages to be spam.

To avoid this problem, and to make geofencing an effective power management tool for a GPS device, embodiments discussed herein provide a system and method by which the geofence calculations are performed inside the GPS device thus eliminating the need to get that information from the server and thus reducing battery consumption associated with the transmission and receipt of data between the tracker and remote server.

FIG. 6 depicts a block diagram of example firmware 600 for implementing a geofence-based power control of a GPS tracker, in embodiments. Firmware 600 may be entirely distinct from firmware 300, discussed above, or may be used in conjunction with and the same as firmware 300. As such, firmware 600 may be implemented in one or both of the processor 112 and memory 110 of the GPS device 102, of FIG. 1. Firmware 600 provides a topology wherein the tracker geofence table is maintained remotely from the cloud server.

Firmware 600 includes a power control module 602, which may be a portion of, or separate from the tracking application module 304 of firmware 300, discussed above. Power control module 602 may include computer readable instructions stored within memory 110 that when executed by processor 112 implement the following functionality. The GPS device 102 may receive user input data 604 (which may the same as user input data 314 of firmware 300), including geofence parameters, such as Latitude/Longitude parameters, or a Latitude/Longitude of the center of a circle along with the radius of the circle. In embodiments, the user input data 604 is received directly from the remote device 124 via network 126. The user input data 604 may also be received via the back-end server 128 without departing from the scope hereof. The user input data 604 is then utilized to create an on-device geofence 606 stored within operating parameters 608. Geofence 606 may be the same as geofence 317 referenced with respect to firmware 300 above. Operating parameters 608 may be the same as operating parameters 312 referenced with respect to firmware 300 above.

Once the GPS device 102 has the on-device geofence 606, it may perform the geofence calculations within its own embedded processor (e.g., processor 112) to determine if the GPS device 102 is inside or outside the geofence 606. This configuration provides the benefit is that no external connection to the server 128 needs to be maintained and thus the GPS device 102 may operate with the transceiver 122 powered off thereby saving power of the power supply 132. Furthermore, the GPS device 102 can instantly determine if it is inside or outside the geofence 606 without delay associated with transmitting data to and receiving data from the server 128. In addition, the GPS device 102 may operate according to one of a plurality of power profiles 612 defined in the power operation schedule 610. For example, a first power profile 612(1) may indicate to operate under low power state when the GPS device 102 is within the boundary defined in the geofence 606. Low power state may include no, or minimal, power supplied to all hardware within the GPS device 102. Low power state may additionally or alternatively include a long interval between “awake” periods in which the GPS receiver 104 is activated (and/or other sensors within the sensor suite 114, and/or the transceiver 122). A second power profile 612(2) may indicate to operate under medium power state when the GPS device 102 is within the boundary defined in the geofence 606 but determined to be near the boundary (e.g., within a predefined distance threshold, such as 10 meters—other distance thresholds may be used without departing from the scope hereof). Medium power state may include no, or minimal, power supplied to all hardware within the GPS device 102 except for the GPS receiver 104. Because the GPS device 102 is identified as near the boundary of the geofence 606, it may be desirable to shorten the interval between “awake” periods of the GPS receiver 104 because the GPS receiver 104 is more likely to cross the boundary of the geofence 606. Medium power state may additionally or alternatively include shorter intervals between “awake” periods in which other sensors within the sensor suite 114, and/or the transceiver 122. A third power profile 612(3) may indicate to operate under high power state when the GPS device 102 is outside the boundary defined in the geofence 606. High power state may include power supplied to all hardware within the GPS device 102 to more accurately determine the status of the GPS device 102 because the device is outside of the geofence boundary. Thus, under the high-power state, the intervals between the “awake” period may be the shorter than the low and medium power states, or the device may always be “awake.”

It should be appreciated that more or fewer power states 612 may be included without departing from the scope hereof. Furthermore, where the firmware 600 is combined with firmware 300, the power states 612 may be different between each given tracking application mode. Additionally, the operating parameters may be configured to select a power state based on on-device data (e.g., on-device data 320). For example, for a vehicle tracking application mode, when the user exits the vehicle and takes his/her phone (which is registered in the paired devices list 303), the GPS device 102 may operate under a different power state 612 based on the data received by BLE sensor 119 indicating absence of a paired device in the paired devices list 303. According, the power state 612 may indicate to activate (e.g., “awaken”) the microphone 117 and control the GPS receiver 104 to capture positional data 105 more frequently. Thus, when the user is away from his/her vehicle, as detected by the BLE sensor 119 indicating absence of the user's phone within range of the BLE sensor 119, heightened tracking of the vehicle may occur to monitor the location of the vehicle more frequently, and monitor ambient noise via the microphone 117 to detect potential glass break and unauthorized entry. Absence of the user's phone from range of the BLE sensor 119 may further configure a geofence (e.g., geofence 317, and/or geofence 606) around the current location of the vehicle (e.g., a 100 ft radius), and breach of the geofence (as indicated by the positional data 105) could cause the GPS device 102 to transmit an alert to the remote device 124 paired with the GPS device 102 as defined in the paired devices list 303.

As another example, the on-device data from the accelerometer 116 may be used to determine whether the GPS device 102 is at rest or moving, and thus whether it is potentially going to cross the boundary of the geofence 606 sooner. The power operation schedule 610 may include a power profile 612 that is activated only when the GPS device 102 is moving towards the boundary of the geofence 606 as determined based on data from the accelerometer 116 and the positional data 105 compared to the geofence 606.

In embodiments, the above described control of selection of power states may be done within the GPS device 102 itself and without requiring the power required to operate the transceiver 122.

FIG. 7 depicts a block diagram of a method 700 for power management of a GPS device based on on-device geofence, in embodiments. Method 700 is implemented using the system described above and depicted in FIGS. 1 and 6 (and optionally FIGS. 1-3, and 6).

In block 702, method 700 receives geofence parameters at the GPS device. In one example of block 702, the GPS device 102 receives user input data 604 from one or both of the remote device 124 and the back-end server 128.

In block 704, the method 700 creates and/or stores a geofence locally on the GPS device. In one example of block 704, the GPS device 102, creates and/or stores the geofence 606 defining a geofence boundary based on a series of Latitude/Longitude points, or a Latitude/Longitude of the center of a circle along with the radius of the circle.

In block 706, the method 700 operates according to one of a plurality of power states based on the GPS device relation to the geofence boundary. In one example of operation of block 706, the GPS device 102 analyzes positional data 105 to determine the position of GPS device 102 with respect to the boundary defined by geofence 606. Depending on this relationship, and based on the configuration of operating parameters 608, the GPS device 102 operates under one of power profiles 612. Block 706 is performed without the GPS device 102 utilizing the transceiver 122 to communicate with the remote device 124 or the back-end server 128. When, however, the relationship of the GPS device 102 to the boundary of the geofence 606 indicates an alert should be transmitted to the remote device 124 or server 128, then the GPS device 102 may activate the transceiver 122 to transmit the necessary alert.

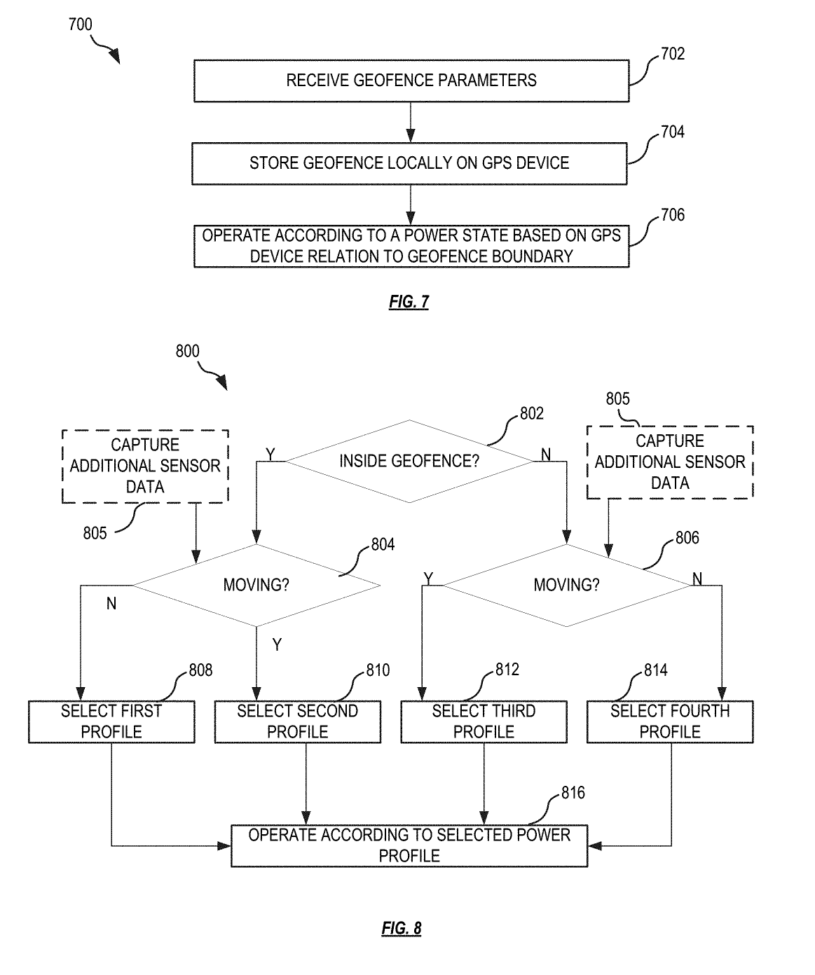

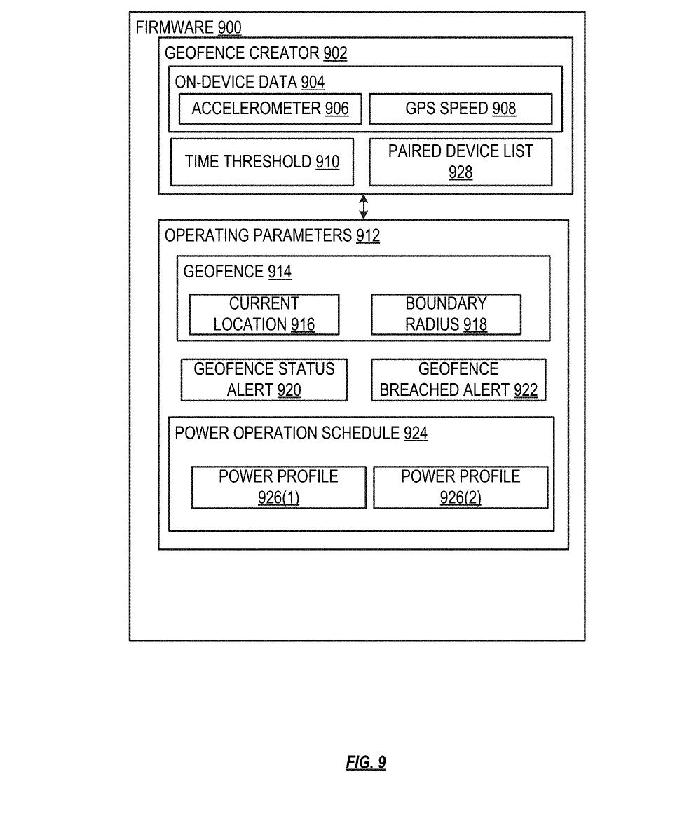

FIG. 8 depicts a block diagram of a method 800 for operating a GPS device between a plurality of power states, in embodiments. Method 800 is an example of block 706 of method 700.

In block 802, method 800 determines if the GPS device is inside the geofence. In one example of block 802, GPS device 102 (using processor 112) analyzes the positional data 105 and determines if the GPS device 102 is within the geofence 606. If so, method 800 proceeds with block 804, else method 800 proceeds with block 806.

In block 804, method 800 determines if the GPS device is moving. In one example of block 804, method 800 analyzes the positional data 105, or the data from the accelerometer 116, to determine if the GPS device 102 is moving. If so, method 800 proceeds with block 808, else method proceeds with block 810. In some embodiments, the decision of whether the GPS device is moving, or, what next block in method 800 to proceed with, may be based on an additional block 805. Block 805 includes capturing additional sensor data at the GPS device. In one example of block 805, the GPS device captures additional data from one or more of the sensors within the sensor suit 114, such as speed, location, time of day, altitude, ambient noise levels, etc.

In block 808, a first power profile of a plurality of power profiles stored locally on the GPS device is selected. The first power profile of the plurality of power profiles is selected in response to determination of a first condition of the GPS device 102 by the power control module 602 (e.g., the GPS device 102 is inside the boundary of the geofence 606 and not moving). In one example of block 808, first power profile 612(1) is selected because the GPS device 102 is located in the boundary of geofence 606, and not moving.

In block 810, a second power profile of the plurality of power profiles stored locally on the GPS device is selected. The second power profile of the plurality of power profiles is selected in response to determination of a second condition of the GPS device 102 by the power control module 602 (e.g., the GPS device 102 is inside the boundary of the geofence 606 and moving). In one example of block 810, first power profile 612(2) is selected because the GPS device 102 is located in the boundary of geofence 606, but is moving. In some embodiments of block 810, the selected power profile in block 810 may also be based on whether the GPS device 102 is determined to be near the boundary of the geofence 606.

In block 806, method 800 determines if the GPS device is moving. Block 806 is similar to block 804. If moving, then method 800 proceeds with block 812, else method 800 proceeds with block 814.

In block 812, a third power profile of the plurality of power profiles stored locally on the GPS device is selected. The third power profile of the plurality of power profiles is selected in response to determination of a third condition of the GPS device 102 by the power control module 602 (e.g., the GPS device 102 is outside the boundary of the geofence 606 and moving). In one example of block 812, third power profile 612(3) is selected because the GPS device 102 is located outside the boundary of geofence 606, and is moving.

In block 814, a fourth power profile of the plurality of power profiles stored locally on the GPS device is selected. The fourth power profile of the plurality of power profiles is selected in response to determination of a fourth condition of the GPS device 102 by the power control module 602 (e.g., the GPS device 102 is inside the boundary of the geofence 606 and not moving). In one example of block 814, an additional power profile 612 is selected because the GPS device 102 is located outside the boundary of the geofence 606. This additional power profile may be the same as the third power profile. Alternatively, because the GPS device 102 is determined to not be moving, the fourth power profile may awaken electronics in the GPS device 102 at longer intervals than the intervals of the third power profile of block 812.

In block 816, the GPS device is operated according to the selected power profile in blocks 808-814. In one example of block 816, the GPS device 102 is operated according to the selected power profile 612. In some embodiments, at any time depending on data received by sensors in the sensor suite 114 (if they are activated as determined by the selected power profile 612), the GPS device 102 may override the selected power profile in order to transmit a required alert. This override may occur, for example, based on the configuration settings of alerts 314, and whether the on-device data 320 breaches an alert threshold 316.

Any of the above described blocks may be included or not included depending on the application. For example, in certain embodiments, blocks 804 and 806 are not included, and a power profile is selected simply based on whether the GPS device 102 is inside or outside the boundary of the geofence 606. When outside the boundary of geofence 606, the power profile may indicate to activate the GPS receiver 104 and transceiver 122 more frequently in order to more accurately track and report, respectively, the location information of the GPS device 102.

### Automatic Geofence Creation on GPS Device:

The above discussion relates to one or more features of a GPS device (e.g., GPS device 102) that may rely on a geofence. As discussed above, geofence operations consume a lot of power and with the small size and small batteries of consumer devices, such as GPS device 102, the battery life expectancy is measured in hours if the GPS device is constantly tracking and reporting—because of required activation and utilization of hardware on the GPS device such as transceiver 122 and GPS receiver 104. Strategic use of a geofence can extend the battery life of the tracker to days or weeks. For example, assuming a user has a geofence centered around his home, if the GPS device were within the geofence, the user would know it was in a well-defined small area and thus would not need constant updates on its location. Thus, the interval between transmissions of data from the GPS device can be longer, the radios and other hardware of the GPS device can be powered down, and battery life can be extended. However, as discussed above with respect to FIGS. 6-8 if the GPS device is outside of the geofence, its position must be determined, the area of location is larger, and most likely the tracker is moving all of which require more frequent updates of the GPS device's position. The radios and other hardware of the GPS device are therefore powered on for longer periods of time consuming more power and decreasing battery life. So, the use of geofences greatly impacts the power consumption and battery life of the GPS device.

Geofences also provide some unique capabilities. Take for example, a person drives his car to the mall to go shopping for a few hours. The person parks the car in the parking lot and enters the mall. When the person returns, the car is gone. According to the FBI crime statistics, car thefts occur with greater frequency where large groups of cars are parked for extended periods of time in places such as shopping centers, colleges, sporting events, movie complexes, and large apartment complexes. If the person is lucky and has a GPS device in his vehicle, he may eventually find the vehicle although many hours will have elapsed due to his time in the mall, reporting the incident to the police, filing a report, etc. By that time, the car could be in another state or disassembled entirely.

The present application acknowledges the above described limitations, and provides a solution via implementing, on-device, a geofence around the GPS tracker when it is stopped and have it automatically trigger an alert that the vehicle is moving without a device paired to the GPS tracker located nearby (indicating the owner of the car is in/nearby the vehicle).

Technically, a geofence could be accomplished in the traditional manner, e.g., as discussed above via manually entering the coordinates of the geofence into a server database and then transmit it to the GPS device. However, manual creation (or even activation) of a geofence every time the vehicle stops is cumbersome, and unlikely to be implemented by a user particularly if there are multiple stops on his trip or if there are unplanned stops that may come up.

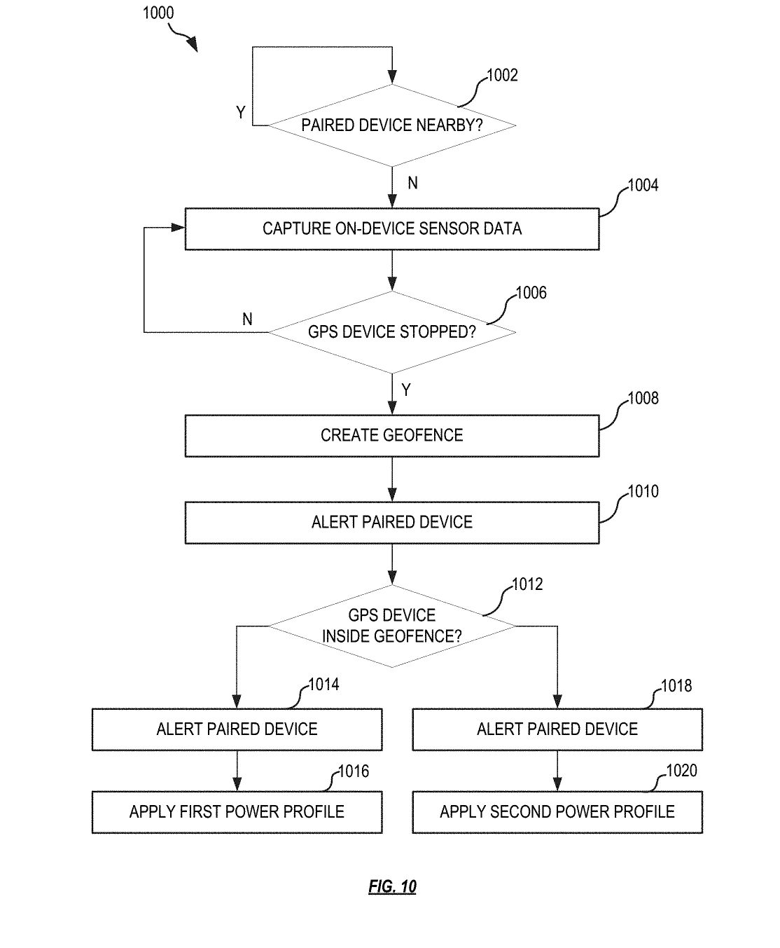

Applicant has determined that battery life of the GPS device 102, and increased security of the tracked object thereby, may be provided using the on-device hardware (such as the GPS receiver 104 and the sensor suite 114). FIG. 9 depicts a block diagram of example firmware 900 for implementing an automatic geofence creation in a GPS tracker, in embodiments. Firmware 900 may be entirely distinct from firmware 300 and/or firmware 600, discussed above, or may be used in conjunction with and/or the same as firmware 300 and/or firmware 600. As such, firmware 900 may be implemented in one or both of the processor 112 and memory 110 of the GPS device 102, of FIG. 1.

Firmware 900 includes a geofence creator 902, which may be a portion of, or separate from the tracking application module 304 of firmware 300, and/or power control module 602 discussed above. Geofence creator 902 may include computer readable instructions stored within memory 110 that when executed by processor 112 implement the following functionality. As discussed above, the GPS device 102 includes a sensor suite 114 that captures data from on-device sensors. The geofence creator 902 logs this data as on-device data 904 (which is like on-device data 320 discussed above). The on-device data 904 may include accelerometer data 906 sensed by accelerometer 116, and a GPS speed vector 908 determined from the positional data 105.

Using the data from the accelerometer 116 and/or a GPS speed vector 908 determined from analyzing the positional data 105, the GPS device 102 (via the processor 112 therein) can determine whether the GPS device 102 is moving or whether it is stopped. When the GPS device 102 has stopped for a pre-determined time (e.g., X minutes) as defined by a time threshold 910, the Geofence Creator 902 is triggered and modifies the operating parameters 912 of the GPS device 102. One such modification is to create a geofence 914. In one embodiment, the geofence creator 902 creates geofence 914 by defining the center point of the geofence 914 as a current location 916 of the GPS device 102 (as indicated by the positional data 105), and an edge of the boundary having a boundary radius 918 of a pre-defined length (e.g., Y meters). The GPS device 102 may then issue an alert 920 indicating that the tracked object is now within the geofence 914. Should the GPS device 102 move from that location outside of the geofence 914, the GPS device 102 may issue a geofence breached alert 922 to the user indicating the vehicle is moving without the user nearby.

The geofence creator 902 may also define operating parameters 912 including modifications to a power operation schedule 924. Accordingly, the geofence creator 902 may implement one or more features discussed above with respect to FIGS. 6-8 in order to define and select one of a plurality of power profiles 926 based on the GPS device 102 relationship to the boundary of the defined geofence 914.

In some embodiments, the geofence creator 902 only generates a status alert 920 if a paired device, as defined in paired device list 928 is nearby the GPS device 102. This embodiment allows the firmware 900 to either not generate, or suppress alerts 920 when the paired device is nearby. Paired device list 928 is the same as paired device list 303 discussed above. When a paired device in the paired device list 928 is within a certain proximity of the GPS device 102 (such as being detectable by the BLE sensor 119, then it is likely that the user of said paired device is near the tracked object being tracked by the GPS device 102. As such, the geofence creator 902 does not need to be activated because it is unlikely that the user will misplace the GPS device 102 and/or tracked object.

In some embodiments, the geofence creator 902 determines the content of the alert 920 based upon whether a paired device, as defined in the paired device list 928 is within a certain proximity of the GPS device 102 (such as being detectable by the BLE sensor 119. For example, the geofence creator 902 may still be initiated if a paired device, as defined in paired device list 928 is nearby the GPS device 102, but the alert 920 may change depending on whether or not a paired device is nearby the GPS device 102. Further, if the GPS device 102 is outside the geofence 914, and a paired device comes within range, the alert 920 may indicate the geofence is being disarmed.

FIG. 10 depicts a block diagram of a method 1000 for automatic on-device creation of a geofence, in embodiments. Method 1000 is implemented using firmware 900, for example.

In block 1002, method 1000 determines a paired device is nearby the GPS device. In one example of block 1002, geofence creator 902 analyzes data from the BLE sensor 119 to determine if a device listed in the paired device list 928 is detected by the BLE sensor 119. If so, method 1000 repeats block 1002 until a paired device is not nearby, and continues to block 1004. Certain embodiments of method 1000 do not include block 1002.

In block 1004, the method 1000 captures on-device sensor data. In one example of block 1004, the GPS device 102 captures data from sensor suite 114, and stores it as on device data 904. For example, the accelerometer data 906 is captured by the accelerometer 116, and the GPS speed vector 908 is determined based on the received positional data 105.

In block 1006, the method analyzes the captured on-device sensor data to determine if the GPS device has stopped for a threshold amount of time. In one example of block 1006, the geofence creator 902 analyzes the accelerometer data 906 and/or GPS speed vector 908 to determine if the GPS device 102 has stopped. If so, method proceeds to block 1008, else, method 1000 repeats block 1004.

In block 1008, the method 1000 creates a geofence around the GPS device. In one example of block 1008, the geofence creator 902 creates geofence 914 around the GPS device 102. The geofence creator 902 may create geofence 914 by defining the center point of the geofence 914 as a current location 916 of the GPS device 102 (as indicated by the positional data 105), and an edge of the boundary having a boundary radius 918 of a pre-defined length (e.g., Y meters).

Block 1008 may further include creating and/or modifying other operating parameters such as definition of one or more of alerts 920, 922, and power operation schedule 924.

Certain embodiments include blocks 1010-1020, or any combination thereof. In embodiments including block 1010, the method 1000 alerts a paired device of the created geofence. In one example of block 1010, alert 920, indicating creation of the geofence 914, is sent using transceiver 122 to a paired device (e.g., remote device 124 or back-end server 128) defined in the paired device list 928.

In embodiments including block 1012, the method 1000 determines if the GPS device is within the geofence created in block 908. For example, the processor 112 of the GPS device 102 may analyze the positional data 105 to determine if the GPS device 102 is within the geofence 914. If so, the method 1000 may proceed with block 1014. Else, the method 1000 may proceed with block 1018.

In embodiments including block 1014, the method 1000 alerts a paired device of location of the GPS device within the created geofence. In one example of block 1014, alert 920, indicating status of the GPS device 102 within the created geofence 914, is sent using transceiver 122 to a paired device (e.g., remote device 124 or back-end server 128) defined in the paired device list 928.

In embodiments including block 1016, the method 1000 selects a power profile associated with the GPS device being within the geofence. In one example of block 1016, the GPS device 102 is configured according to first power profile 926(1) defined in power operation schedule 924 and being associated with the GPS device 102 being located within the geofence 914.

In embodiments including block 1018, the method 1000 alerts a paired device of the GPS device breaching the created geofence. In one example of block 1014, alert 922, indicating status of the GPS device 102 breaching the created geofence 914, is sent using transceiver 122 to a paired device (e.g., remote device 124 or back-end server 128) defined in the paired device list 928.

In embodiments including block 1020, the method 1000 selects a power profile associated with the GPS device breaching the geofence. In one example of block 1020, the GPS device 102 is configured according to second power profile 926(2) defined in power operation schedule 924 and being associated with the GPS device 102 breaching the geofence 914.

It should be appreciated that more or fewer power profiles may be defined without departing from the scope hereof. Further, the method 1000 may be interrupted at any time based on a change in location of the GPS device 102 with respect to the boundary of the geofence 914, or with respect to proximity to a paired device defined in the paired device list 928. For example, when a paired device comes within range to the GPS device 102 after the geofence 914 has been breached by the GPS device 102, the geofence 914 may be deactivated and/or a new power profile 926 may be triggered.

Firmware 900 and method 1000 provide an advantage that anytime a GPS device 102 is stopped for X minutes (or any other given time period or stopped within a given area/location), a geofence is automatically created, so no matter how many stops (planned or unplanned) the GPS device 102 makes a geofence will be set up. An additional benefit to this is that when the GPS device 102 is not moving it can use the power profiles that have been created for when it is inside the GPS device 102, thus also conserving power and extending battery life.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

1. A GPS device with configurable tracking modes, comprising:
one or more processors;
memory operatively coupled with the one or more processors and storing computer readable instructions that when executed by the one or more processors cause the one or more processors to:
receive a tracking application mode selection message defining a tracking application mode selected by a user associated with the GPS device, and
configure operating parameters of the GPS device according to the tracking application mode.

2. The GPS device of claim 1, the computer readable instructions causing the one or more processors to configure the operating parameters by selecting an operating profile from a plurality of pre-set profiles stored in the memory.

3. The GPS device of claim 1, the tracking application mode selection message including an operating profile, and being received from a back-end server.

4. The GPS device of claim 1, the operating parameters including one or more of an alert to be transmitted from the GPS device to one or more of a remote device and a backend server, alert thresholds defining conditions of the GPS device required to transmit the alert, sensor operating parameters defining operating conditions of sensors located in the GPS device, and a power operation schedule defining power modes of a power supply of the GPS device.

5. The GPS device of claim 1, the computer readable instructions further causing the one or more processors to pair, prior to receiving the tracking application mode selection message, the GPS device with a remote device, and store, in the memory, a paired devices list of each remote device paired with the GPS device.

6. The GPS device of claim 1, the computer readable instructions further causing the one or more processors to:
receive user input data defining user selected operating parameters, and
modify the operating parameters of the GPS device based on the user input data.

7. The GPS device of claim 6, the user input data including one or more of user-defined geofences, information of an object tracked by the GPS device, requested alerts, alert thresholds that trigger the requested alerts or the alert.

8. The GPS device of claim 1, the computer readable instructions further causing the one or more processors to:
store on-device data collected by one or more sensors in the GPS device, and
modify the operating parameters based on the on-device data.

9. The GPS device of claim 8, the sensors including an accelerometer, a microphone, a temperature sensor, a Bluetooth low energy sensor, and a pressure sensor.

10. The GPS device of claim 8, the computer readable instructions further causing the one or more processors to: modify an alert threshold associated with a sensor in the GPS device collecting data having a jitter profile.

11. The GPS device of claim 10, the computer readable instructions further causing the one or more processors to: identify the jitter profile.

12. The GPS device of claim 8, the computer readable instructions further causing the one or more processors to: modify the operating parameters based on historical analysis of the on-device data.

13. The GPS device of claim 12, the computer readable instructions further causing the one or more processors to:
transmit the on-device data to a back-end server, and
receive an update to the operating parameters from the back-end server,
wherein the historical analysis completed at the back-end server.

14. The GPS device of claim 13, the historical analysis including an artificial intelligence or machine learning algorithm.

15. The GPS device of claim 1, further comprising a Bluetooth Low Energy (BLE) sensor;
the operating parameters defining a low-power mode and a high-power mode, and controlling the GPS device to monitor one or more remote devices listed in a paired device list such that
when one of the remote devices listed in the paired device is detectable by the BLE sensor, the GPS device is controlled into a low-power mode, and
when one of the remote devices listed in the paired device is not detectable by the BLE sensor, the GPS device is controlled into a high-power mode.

16. The GPS device of claim 15, the low-power mode defining a first activation interval of a GPS receiver in the GPS device and/or a sensor in the GPS device, the high-power mode defining a second activation interval of the GPS receiver or the sensor, the first activation interval being longer than the second activation interval.

17. The GPS device of claim 15, the high-power mode activating a microphone of the GPS device and the operating parameters controlling the GPS device to monitor the signal received from the microphone during the high-power mode to detect changes in the ambient noise around the GPS device above a defined threshold.

18. The GPS device of claim 1,
the operating parameters including a geofence and a plurality of power profiles stored in the memory;
the computer readable instructions further causing the one or more processors to, without control by a remote device or back-end server:
analyze positional data captured by a GPS receiver of the GPS device,
configure the GPS device according to a first of the power profiles when the GPS device is located within a boundary of the geofence, and
configure the GPS device according to a second of the power profiles when the GPS device is located outside a boundary of the geofence.

19. The GPS device of claim 1, the computer readable instructions further causing the one or more processors to, without control by a remote device or back-end server:
collect, from one or more sensors located in the GPS device, data including accelerometer data and a GPS speed vector, and
create a geofence when the accelerometer data or the GPS speed vector indicates the GPS device has not moved for a pre-defined threshold of time.

20.-93. (canceled)
